(19) United States
(12) Patent Application Publication
(10) Pub. No.: US 2016/0225332 A1
(43) Pub. Date: Aug. 4, 2016

(54) SELF-POWER FEEDING TYPE DISPLAY DEVICE

(71) Applicant: Kabushiki Kaisha Toshiba, Minato-ku (JP)

(72) Inventor: Soichiro UENO, Ota (JP)

(73) Assignee: Kabushiki Kaisha Toshiba, Minato-ku (JP)

(21) Appl. No.: 15/010,417

(22) Filed: Jan. 29, 2016

(30) Foreign Application Priority Data
Feb. 4, 2015 (JP) 2015-020233

(51) Int. Cl. G09G 3/36; H02J 7/35

(52) U.S. Cl. CPC G09G 3/3607; H02J 7/35; G09G 2300/0456; G09G 2330/023; G09G 2360/148

(57) ABSTRACT

Certain embodiments provide a self-power feeding type display device including a reflection unit, a power generation unit, and a power storage unit. The reflection unit reflects light in a first band. The power generation unit absorbs light in a second band different from the first band and generates power. The power storage unit stores power generated in the power generated in the power generation unit. The self-power feeding type display device is a display device configured by arranging a plurality of reflection pixels obtained by laminating the reflection unit and the power generation unit.

### CROSS REFERENCE TO RELATED APPLICATIONS

This application is based upon and claims the benefit of priority from the prior Japanese Patent Application No. 2015-020233 filed in Japan on Feb. 4, 2015; the entire contents of which are incorporated herein by reference.

### FIELD

Embodiments described herein relate generally to a self-power feeding type display device.

### BACKGROUND

In recent years, improvement of various devices with the object of reducing energy consumption quantity has been regarded as serious. Under the circumstances, reduction of power consumption is also demanded for a display device used as, for example, an electronic poster that always displays a predetermined picture.

However, there is a limit in reduction of power consumption. It is becoming difficult to further reduce a supply quantity of power generated outside of the display device while demanded performance for the display device is maintained.

### BRIEF DESCRIPTION OF THE DRAWINGS

FIG. 1 is a top view schematically illustrating a self-power feeding type display device according to a first embodiment;

FIG. 2 is an enlarged top view illustrating a portion of the self-power feeding type display device illustrated in FIG. 1;

FIG. 3A is a sectional view of one pixel group along a dot-dash line Xa-Xa′ illustrated in FIG. 2;

FIG. 3B is a sectional view of one pixel group along a dot-dash line Xb-Xb′ illustrated in FIG. 2;

FIG. 4 is a schematic perspective view for explaining a manufacturing method of the self-power feeding type display device according to the first embodiment;

FIG. 5A is a sectional view corresponding to FIG. 3A, for explaining moves of light incident on the self-power feeding type display device according to the first embodiment;

FIG. 5B is a sectional view corresponding to FIG. 3B, for explaining moves of light incident on the self-power feeding type display device according to the first embodiment;

FIG. 6 is a functional block diagram illustrating the self-power feeding type display device according to the first embodiment;

FIG. 7A is a sectional view corresponding to FIG. 3A, of one pixel group included in a self-power feeding type display device according to a modification of the first embodiment;

FIG. 7B is a sectional view corresponding to FIG. 3B, of one pixel group included in the self-power feeding type display device according to the modification of the first embodiment;

FIG. 8 is a schematic perspective view for explaining a manufacturing method of the self-power feeding type display device according to the modification of the first embodiment;

FIG. 9A is a sectional view corresponding to FIG. 7A, for explaining moves of light incident on the self-power feeding type display device according to the modification of the embodiment of the first embodiment;

FIG. 9B is a sectional view corresponding to FIG. 7B, for explaining moves of light incident on the self-power feeding type display device according to the modification of the first embodiment;

FIG. 10 is a functional block diagram illustrating the self-power feeding type display device according to the modification of the first embodiment;

FIG. 11 is an enlarged top view corresponding to FIG. 2, illustrating a portion of the self-power feeding type display device according to a second embodiment;

FIG. 12A is a sectional view of one pixel group along a dot-dash line Xa-Xa′ illustrated in FIG. 11;

FIG. 12B is a sectional view of one pixel group along a dot-dash line Xb-Xb′ illustrated in FIG. 11;

FIG. 13A is a sectional view corresponding to FIG. 12A, illustrating an example of a structure of a reflection layer in a self-power feeding type display device according to the second embodiment;

FIG. 13B is a sectional view corresponding to FIG. 12B, illustrating an example of a structure of a reflection layer in a self-power feeding type display device according to the second embodiment;

FIG. 14 is a schematic perspective view for explaining a manufacturing method of the self-power feeding type display device according to the second embodiment;

FIG. 15A is a sectional view corresponding to FIG. 12A, for explaining moves of light incident on the self-power feeding type display device according to the second embodiment;

FIG. 15B is a sectional view corresponding to FIG. 12B, for explaining moves of light incident on the self-power feeding type display device according to the second embodiment;

FIG. 16 is a functional block diagram illustrating the self-power feeding type display device according to the second embodiment;

FIG. 17A is a sectional view corresponding to FIG. 12A, of one pixel group included in a self-power feeding type display device according to a modification of the second embodiment;

FIG. 17B is a sectional view corresponding to FIG. 12B, of one pixel group included in the self-power feeding type display device according to the modification of the second embodiment;

FIG. 18 is a schematic perspective view for explaining a manufacturing method of the self-power feeding type display device according to the modification of the second embodiment;

FIG. 19A is a sectional view corresponding to FIG. 17A, for explaining moves of light incident on the self-power feeding type display device according to the modification of the embodiment of the second embodiment;

FIG. 19B is a sectional view corresponding to FIG. 17B, for explaining moves of light incident on the self-power feeding type display device according to the modification of the second embodiment; and

FIG. 20 is a functional block diagram illustrating the self-power feeding type display device according to the modification of the second embodiment.

### DESCRIPTION OF THE EMBODIMENTS

Certain embodiments provide a self-power feeding type display device including a reflection unit, a power generation unit, and a power storage unit. The reflection unit reflects light in a first band. The power generation unit absorbs light in a second band different from the first band and generates power. The power storage unit stores electricity generated in the power generation unit. The self-power feeding type display device is a display device configured by arranging a plurality of reflection pixels each formed by laminating the reflection unit and the power generation unit.

The self-power feeding type display device described hereafter is a display device capable of displaying a desired picture by reflecting light which is included in incident light and has waveforms in a predetermined band and capable of generating power by absorbing light which is included in the incident light and has waveforms outside the predetermined band. The display device absorbs light that are unnecessary for display of the picture in the display device and generates power. Therefore, it is possible to reduce a supply quantity of power generated outside the display device to the display device. Hereafter, embodiments of such a display device will be described with reference to the drawings.

### First Embodiment

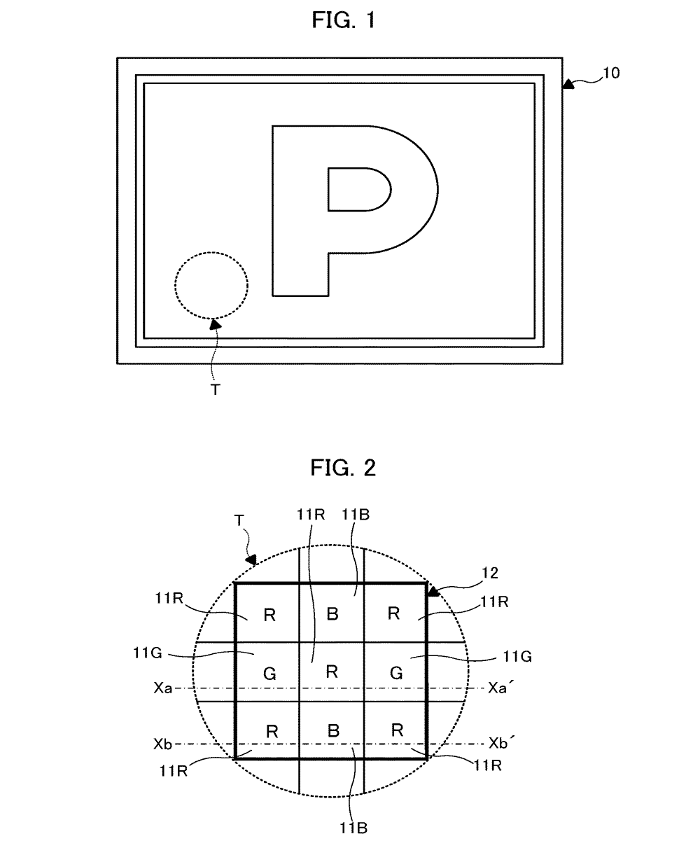

FIG. 1 is a top view schematically illustrating a self-power feeding type display device according to a first embodiment. A self-power feeding type display device illustrated in FIG. 1 is an electronic poster that displays a desired picture by two-dimensionally arranging reflection pixels that reflect light which is included in incident light and has wavelengths in a predetermined band. By the way, the incident light may be natural light such as sunlight, or may be light emitted from a white-colored light source or the like provided separately to irradiate the self-supply type display device 10.

FIG. 2 is an enlarged top view illustrating a portion (an area T surrounded by a dash line circle in FIG. 1) of the self-power feeding type display device illustrated in FIG. 1. As illustrated in FIG. 2, the self-power supply feeding device 10 is configured by arranging a plurality of reflection pixels two-dimensionally. Each of the plurality of reflection pixels is, for example, one of a red color reflection pixel 11R, which reflects red color light, a green color reflection pixel 11G, which reflects green color light, and a blue color reflection pixel 11B, which reflects blue color light. In the self-power feeding type display device 10, such a plurality of reflection pixels 11R, 11G and 11B are selected suitably according to a displayed picture and arranged. In the self-power feeding type display device 10 according to the present embodiment, nine reflection pixels each of which is one of a red color reflection pixel 11R, a green color reflection pixel 11G, and a blue color reflection pixel 11B form a pixel group 12. In the pixel group 12, nine reflection pixels is arranged so that reflection pixels of the same color are not adjacent to each other. The self-power feeding type display device 10 according to the present embodiment is configured by arranging such a plurality of pixel groups 12 two-dimensionally.

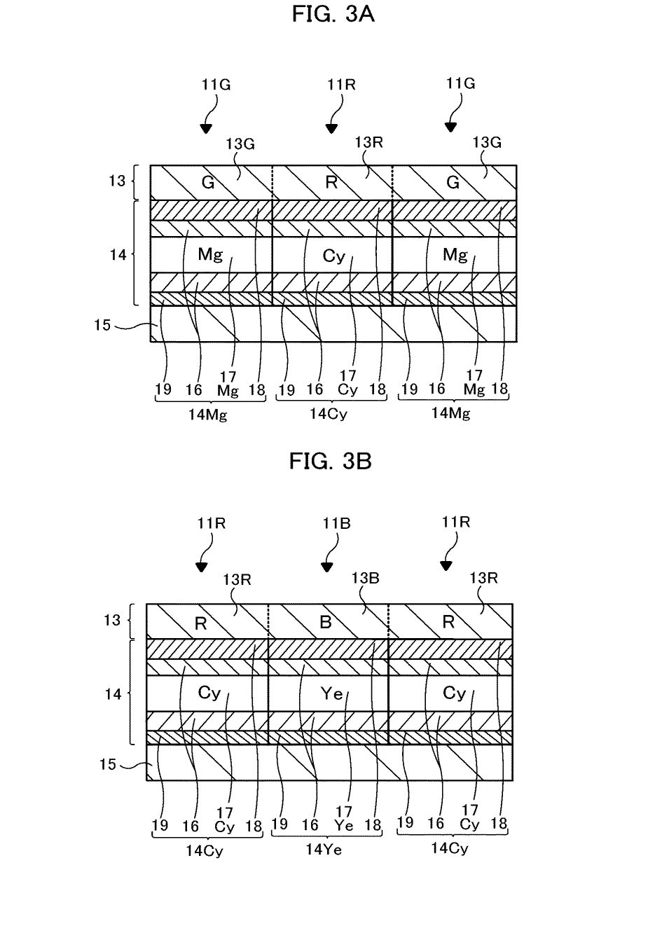

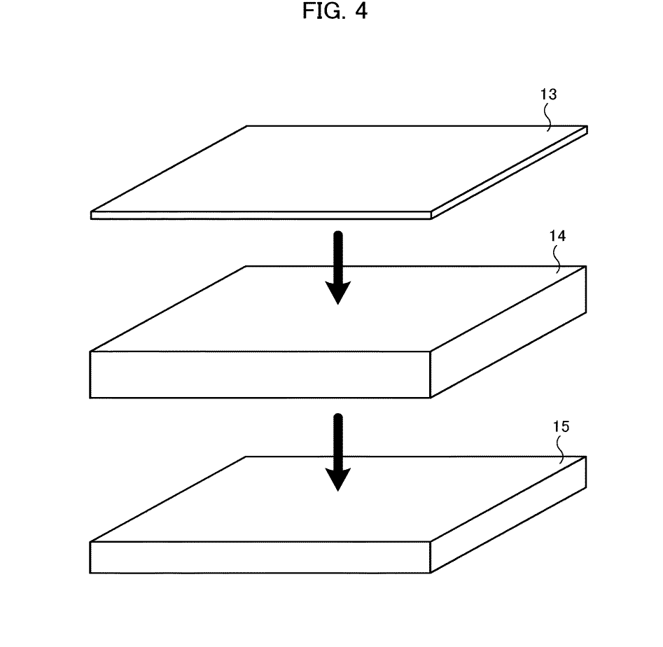

FIG. 3A is a sectional view of one pixel group 12 along a dot-dash line Xa-Xa′ illustrated in FIG. 2, and FIG. 3B is a sectional view of one pixel group 12 along a dot-dash line Xb-Xb′ illustrated in FIG. 2. Hereafter, structure of respective reflection pixels 11R, 11G and 11B will is described in detail with reference to FIG. 3A and FIG. 3B.

As illustrated in FIG. 3A and FIG. 3B, the red color reflection pixel 11R includes a red color reflection unit 13R, which reflects red color light and transmits light other than red color light (light of cyan (Cy) color). In addition, the red color reflection pixel 11R includes a cyan color power generation unit 14Cy, which absorbs cyan color light and generates power, and a power storage unit 15, which stores power generated in the cyan color power generation unit 14Cy. In the red color reflection pixel 11R, the cyan color power generation unit 14Cy and the red color reflection unit 13R are laminated on the power storage unit 15 in the cited order.

In the same way, as illustrated in FIG. 3A, the green color reflection pixel 11G includes a green color reflection unit 13G, which reflects green color light and transmits light other than green color light (light of the magenta (Mg) color). In addition, the green color reflection pixel 11G includes a magenta color power generation unit 14Mg, which absorbs magenta color light and generates power, and the power storage unit 15, which stores power generated in the magenta color power generation unit 14Mg. In the green color reflection pixel 11G, the magenta color power generation unit 14Mg and green color reflection unit 13G are laminated on the power storage unit 15 in the cited order.

As illustrated in FIG. 3B, the blue color reflection pixel 11B includes a blue color reflection unit 13B, which reflects blue color light and transmits light other than blue color light (yellow (Ye) color light). In addition, the blue color reflection pixel 11B includes a yellow color power generation unit 14Ye, which absorbs yellow color light and generates power, and the power storage unit 15, which stores power generated in the yellow color power generation unit 14Ye. In the blue color reflection pixel 11B, the yellow color power generation unit 14Ye and the blue color reflection unit 13B are laminated on the power storage unit 15 in the cited order.

As illustrated in FIG. 3A and FIG. 3B, a plurality of reflection units 13R, 13G and 13B configure a reflection layer 13 of a single layer in the pixel group 12. The reflection layer 13 of the single layer is, for example, a cholesteric liquid crystal layer of a single layer capable of varying a reflection band every predetermined region.

Cholesteric liquid crystal that configures the cholesteric liquid crystal layer has a property of reflecting light of an arbitrary wavelength according to an orientation state of the cholesteric liquid crystal. The orientation state of the cholesteric liquid crystal can be controlled arbitrarily by applying a strong electric field temporarily. In addition, the cholesteric liquid crystal has a property of maintaining the orientation state of the cholesteric liquid crystal if application of the electric field is stopped after the cholesteric liquid crystal is brought into a desired orientation state by applying the electric field. The above-described reflection layer 13 of the single layer is a cholesteric liquid crystal layer configured by cholesteric liquid crystal having such a property.

By the way, it suffices that each of the reflection units 13R, 13G, and 13B of respective colors is capable of reflecting light having a wavelength in a predetermined band and transmitting light outside the band. Therefore, materials configuring the reflection units 13R, 13G, and 13B and structures such as film thicknesses may be different from each other. That is, the plurality of reflection units 13R, 13G, and 13B maybe reflection layers that are independent from each other.

The plurality of power generation units 14Cy, 14Mg, and 14Ye are configured by organic solar batteries, which absorb light transmitted by the reflection units 13R, 13G, and 13B respectively that is unnecessary for display of the picture and generate power. That is, for example, the cyan color power generation unit 14Cy has a structure in which an electrolyte layer 17Cy including titanium dioxide with a cyan color pigment adsorbed is filled between one pair of opposed transparent electrodes 16. In the same way, the magenta color power generation unit 14Mg has a structure in which an electrolyte layer 17Mg including titanium dioxide with a magenta color pigment adsorbed is filled between one pair of opposed transparent electrodes 16. The yellow color power generation unit 14Ye has a structure in which an electrolyte layer l7Ye including titanium dioxide with a yellow color pigment adsorbed is filled between one pair of opposed transparent electrodes 16.

By the way, each of the plurality of power generation units 14Cy, 14Mg, and 14Ye having the configuration described heretofore has a reflection reducing film 18 on the transparent electrode 16 of an upper layer and has a reflection film 19 under the transparent electrode 16. As a result, the power generation efficiency in each of the power generation units 14Cy, 14Mg, and 14Ye is improved.

If light is incident on each of such power generation units 14Cy, 14Mg, and 14Ye which are configured by organic solar batteries, the light excites electrons in the pigment. The excited electrons are led to the transparent electrode 16 (cathode) via titanium dioxide and taken out as a direct current. The electrons sent out return to the opposed transparent electrode 16 (anode) via an external circuit, and return to the pigment again via ions in the electrolyte layers l7Cy, 17Mg, and 17Ye sandwiched between the transparent electrodes 16. In this way, the light is absorbed and power is generated.

The plurality of power generation units 14Cy, 14Mg, and 14Ye each of which is configured by the organic solar battery configure a power generation layer 14 in one pixel group 12.

The power storage unit 15 included in the reflection pixels 11R, 11G and 11B of respective colors is configured by a capacitor layer of a single layer or a battery layer of a single layer, and is capable of store power generated in the power generation units 14Cy, 14Mg, and 14Ye.

As illustrated in FIG. 4, the self-power feeding type display device 10 configured by the reflection pixels 11R, 11G, and 11B having such structures can be manufactured by forming each of the reflection layer 13, the power generation layer 14, and the power storage layer 15 in a sheet form and sticking the sheet-like layers 13, 14, and 15 together. Therefore, for example, a self-feeding type display device having a large screen can be manufactured easily.

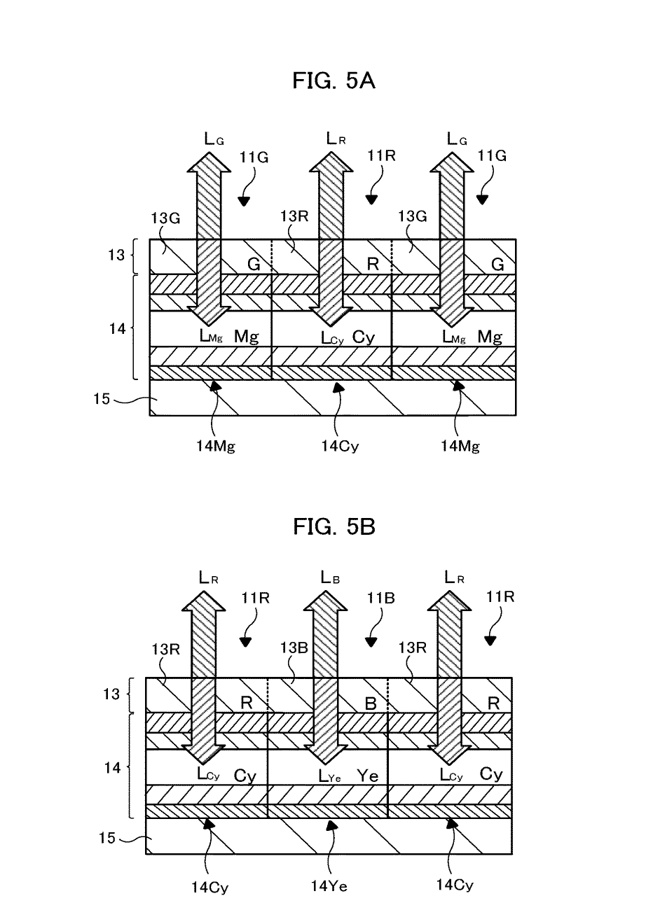

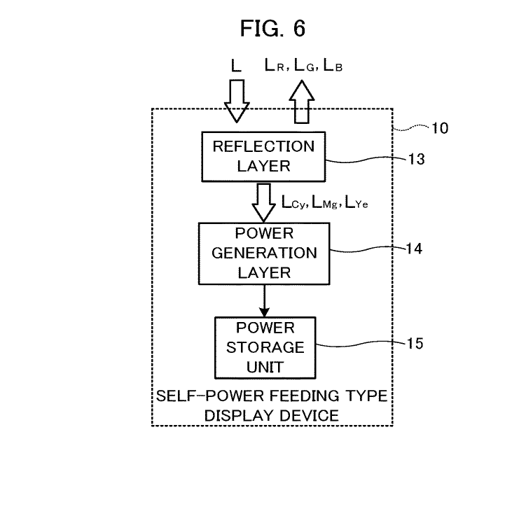

Operation of such a self-power feeding type display device will now be described with reference to FIG. 5A, FIG. 5B, and FIG. 6. FIG. 5A is a sectional view corresponding to FIG. 3A, for explaining moves of light incident on the self-power feeding type display device 10 according to the first embodiment. FIG. 5B is a sectional view corresponding to FIG. 3B, for explaining moves of light incident on the self-power feeding type display device 10 according to the first embodiment. FIG. 6 is a functional block diagram illustrating the self-power feeding type display device 10 according to the first embodiment.

First, if the incident light L is incident on the self-power feeding type display device 10, light having a wavelength in a predetermined band is reflected in the reflection layer 13. As illustrated in FIG. 5A and FIG. 5B, if the incident light L is incident on, for example, the red color reflection pixel 11R, the red color reflection unit 13R reflects red color light L_{R} included in the incident light L. In the same way, if the incident light L is incident on the green color reflection pixel 11G, the green color reflection unit 13G reflects green color light L_{G} included in the incident light L. If the incident light L is incident on the blue color reflection pixel 11B, the blue color reflection unit 13B reflects blue color light L_{B} included in the incident light L. In this way, the reflection layer 13 reflects light in a predetermined band. As a result, the self-power feeding type display device 10 is capable of displaying a picture according to a pixel arrangement.

Light L_{cy}, L_{Mg}, and L_{ye} which is included in the incident light L incident on the self-power feeding type display device 10 and other than light reflected in the reflection layer 13 is transmitted by the reflection layer 13 and arrives at the power generation layer 14. The light L_{cy}, L_{Mg}, and L_{ye} that arrives at the power generation layer 14 is absorbed in the power generation layer 14, and power is generated. As illustrated in FIG. 5A and FIG. 5B, for example, the cyan (Cy) color light L_{cy} which is transmitted through the red color reflection unit 13R arrives at the cyan color power generation unit 14Cy included in the red color reflection pixel 11R. The cyan color power generation unit 14Cy absorbs the light L_{cy} which arrives at the layer 14Cy, and generates power. In the same way, the magenta (Mg) color light L_{Mg} which is transmitted through the green color reflection unit 13G arrives at the magenta color power generation unit 14Mg included in the green color reflection pixel 11G. The magenta color power generation unit 14Mg absorbs the light L_{Mg} which arrives at the layer 14Mg, and generates power. The yellow (Ye) color light L_{Ye} which is transmitted through the blue color reflection unit 13B arrives at the yellow color power generation unit 14Ye included in the blue color reflection pixel 11B. The yellow color power generation unit 14Ye absorbs the light L_{Ye} arriving at the layer 14Ye, and generates power. In this way, the light L_{cy}, L_{Mg}, and L_{ye} other than light reflected in the reflection layer 13 is absorbed in the power generation layer 14. As a result, the self-power feeding type display device 10 can absorb the light L_{cy}, L_{Mg}, and L_{ye} that is unnecessary for display of the picture, and generate power.

As illustrated in FIG. 6, the power generation layer 14 and the power storage unit 15 are connected electrically by wiring, which is not illustrated. Power generated in the power generation layer 14 can be stored in the power storage unit 15. The power stored in the power storage unit 15 can be taken out as occasion demands. Power required when the self-power feeding type display device 10 operates can be taken out from the power storage unit and used.

In the self-power feeding type display device 10 according to the first embodiment described heretofore, it is possible to absorb the light L_{cy}, L_{Mg}, and L_{ye} that is unnecessary for display of the picture in the power generation layer 14, generate power, and store the power in the power storage unit 15. The self-power feeding type display device 10 can operate by taking out the power stored in the power storage unit 15 and using the power. Therefore, the supply quantity of power generated outside the self-power feeding type display device 10 to the self-power feeding type display device 10 can be reduced.

Furthermore, in the self-power feeding type display device 10 according to the first embodiment, the reflection layer 13 is disposed on the power generation layer 14. Therefore, it is possible to suppress attenuation of the incident light which is incident on the self-power feeding type display device 10, in the power generation layer 14. In addition, it is also possible to suppress attenuation of light which is reflected in the reflection layer 13, in the power generation layer 14. Even if the light quantity of the incident light which is incident on the self-power feeding type display device 10 is small, therefore, a desired picture can be displayed normally.

### <Modification>

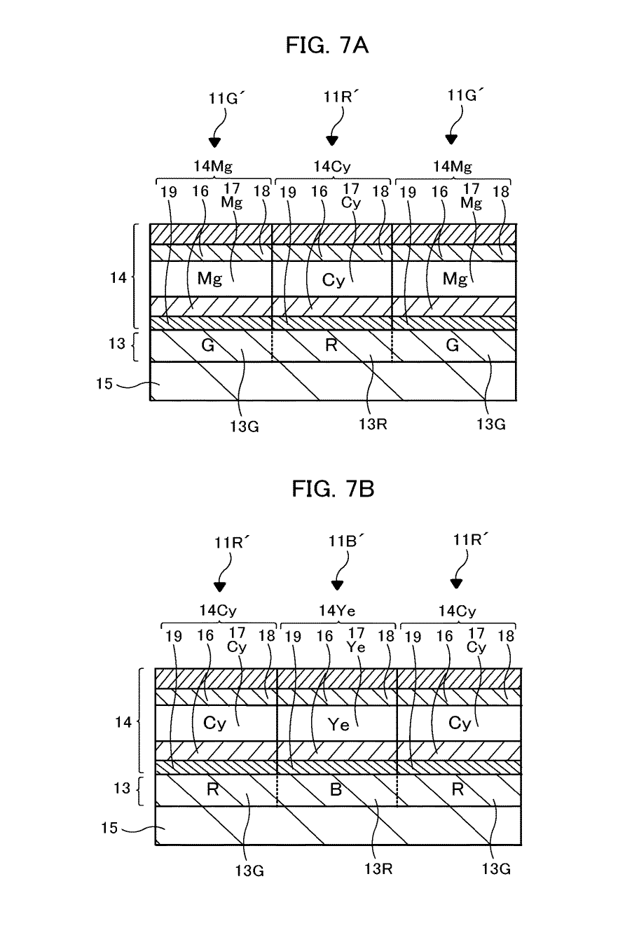

FIG. 7A is a sectional view corresponding to FIG. 3A, illustrating one pixel group in a self-power feeding type display device according to a modification of the first embodiment. FIG. 7B is a sectional view corresponding to FIG. 3B, illustrating one pixel group in the self-power feeding type display device according to the modification of the first embodiment. As illustrated in FIG. 7A and FIG. 7B, the reflection layer 13 and the power generation layer 14 may be laminated on the power storage unit 15 of the single layer in the cited order. That is, it is also possible to configure a red color reflection pixel 11R′ by laminating the red color reflection color reflection unit 13R and the cyan color power generation unit 14Cy on the power storage unit 15 in the cited order, configure a green color reflection pixel 11G′ by laminating the green color reflection color reflection unit 13G and the magenta color power generation unit 14Mg on the power storage unit in the cited order, and configure a blue color reflection pixel 11B′ by laminating the blue color reflection color reflection unit 13B and the yellow color power generation unit 14Ye on the power storage unit 15 in the cited order.

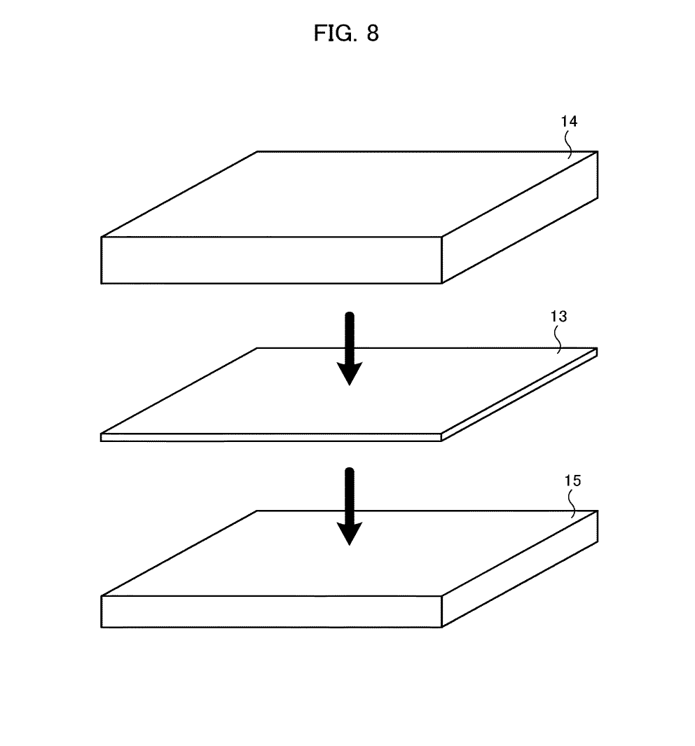

A self-power feeding type display device configured by the reflection pixels 11R′ , 11G′ , and 11B′ having such structures can be manufactured in the same way as the self-power feeding type display device 10. That is, as illustrated in FIG. 8, the self-power feeding type display device can be manufactured by forming each of the reflection layer 13, the power generation layer 14, and the power storage layer 15 in a sheet form and sticking the sheet-like layers 13, 14, and 15 together.

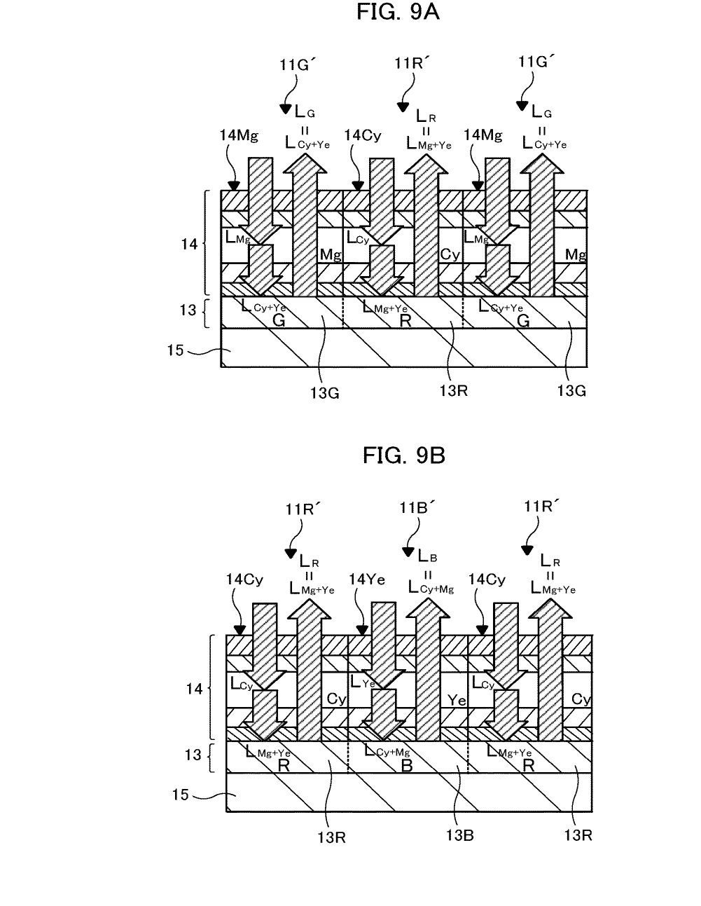

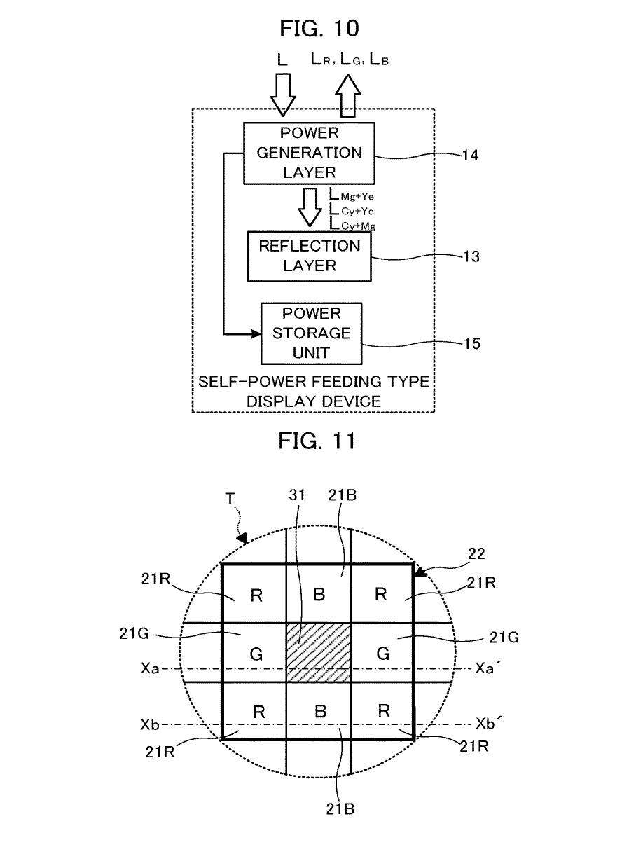

Operation of such a self-power feeding type display device will now be described with reference to FIG. 9A, FIG. 9B, and FIG. 10. FIG. 9A is a sectional view corresponding to FIG. 7A, for explaining moves of light incident on the self-power feeding type display device according to the modification of the first embodiment. FIG. 9B is a sectional view corresponding to FIG. 7B, for explaining moves of light incident on the self-power feeding type display device according to the modification of the first embodiment. FIG. 10 is a functional block diagram illustrating the self-power feeding type display device according to the modification of the first embodiment.

First, if the incident light L is incident on the self-power feeding type display device according to the modification, light having a wavelength in a predetermined band is absorbed in the power generation layer 14 and power is generated. As illustrated in FIG. 9A and FIG. 9B, in the cyan color power generation unit 14Cy, cyan color light L_{Cy} which is included in the incident light L arriving at the layer 14Cy is absorbed and power is generated. In the same way, in the magenta color power generation unit 14Mg, magenta color light L_{Mg}, which is included in the incident light L arriving at the layer 14Mg is absorbed and power is generated. In the yellow color power generation unit 14Ye, yellow color light L_{Ye} which is included in the incident light L arriving at the layer 14Ye is absorbed and power is generated.

Light that is not absorbed in the power generation layer 14 is transmitted by the power generation layer 14 and arrives at the reflection layer 13. The light arriving at the reflection layer 13 is reflected in the reflection layer 13, transmitted by the power generation layer 14, and emitted to the outside of the self-power feeding type display device according to the modification. As illustrated in FIG. 9A and FIG. 9B, light L_{Mg+Ye} of magenta color+yellow color, which is not absorbed in the cyan color power generation unit 14Cy, i.e., the red color light L_{R} is transmitted by the cyan color power generation unit 14Cy and arrives at the red color reflection unit 13R. The light arriving at the red color reflection unit 13R is reflected in the red color reflection unit 13R, transmitted by the cyan color power generation unit 14Cy, and emitted to the outside of the self-power feeding type display device according to the modification. In the same way, light L_{Cy+Ye} of cyan color+yellow color, which is not absorbed in the magenta color power generation unit 14Mg, i.e., the green color light L_{G} is transmitted by the magenta color power generation unit 14Mg and arrives at the green color reflection unit 13G. The light arriving at the green color reflection unit 13G is reflected in the green color reflection unit 13G, transmitted by the magenta color power generation unit 14Mg, and emitted to the outside of the self-power feeding type display device according to the modification. Light L_{Cy-Mg} of cyan color+magenta color, which is not absorbed in the yellow color power generation unit 14Ye, i.e., the blue color light L_{B} is transmitted by the yellow color power generation unit 14Ye and arrives at the blue color reflection unit 13B. The light arriving at the blue color reflection unit 13B is reflected in the blue color reflection unit 13B, transmitted by the yellow color power generation unit 14Ye, and emitted to the outside of the self-power feeding type display device according to the modification. In this way, the reflection layer 13 reflects light having a wavelength in a predetermined band. As a result, the self-power feeding type display device according to the modification can display a picture according to a pixel arrangement. In addition, the self-power feeding type display device according to the modification can absorb the light L_{cy}, L_{Mg}, and L_{ye}, which is unnecessary for display of the picture, and generate power.

As illustrated in FIG. 10, the power generation layer 14 and the power storage unit 15 are connected electrically by wiring, which is not illustrated. Power generated in the power generation layer 14 can be stored in the power storage unit 15. The power stored in the power storage unit 15 can be taken out as occasion demands. Power required when the self-power feeding type display device according to the modification operates can be taken out from the power storage unit 15 and used.

In the self-power feeding type display device according to the modification of the first embodiment described heretofore, it is also possible to reduce the supply quantity of power generated outside the self-power feeding type display device to the self-power feeding type display device by a reason similar to that of the self-power feeding type display device 10 according to the first embodiment.

Furthermore, in the self-power feeding type display device according to the modification of the first embodiment, the reflection layer 13 is disposed on the power generation layer 14. Therefore, it is possible to increase the absorption quantity of light in the power generation layer 14 as compared with the self-power feeding type display device 10 according to the first embodiment. Accordingly, the power generation quantity can be increased.

### Second Embodiment

A self-power feeding type display device according to a second embodiment differs from the self-power feeding type display device 10 according to the first embodiment in that a displayed picture can be changed without changing the pixel arrangement. A change only in color is also included in change of a picture referred to herein. That is, a change of a letter “P” illustrated in FIG. 1 to, for example, a letter “Q” is included in the picture change. In addition, a case where the letter “P” illustrated in FIG. 1 is not changed, but the color of the letter “P” is changed is also included in the picture change. Hereafter, such a self-power feeding type display device will be described with reference to the drawings.

FIG. 11 is an enlarged top view corresponding to FIG. 2, illustrating a portion of the self-power feeding type display device according to the second embodiment. The self-power feeding type display device has a plurality of pixel groups 22, each of which includes a plurality of reflection pixels and at least one sensor pixel 31. The self-power feeding type display device according to the second embodiment is configured by arranging such a plurality of pixel groups 22 two-dimensionally.

Each of the plurality of reflection pixels included in each pixel group 22 is any one of a red color reflection pixel 21R, which reflects red color light, a green color reflection pixel 21G, which reflects green color light, and a blue color reflection pixel 21B, which reflects blue color light, in the same way as, for example, the self-power feeding type display device 10 according to the first embodiment. In the self-power feeding type display device according to the second embodiment, such a plurality of reflection pixels 21R, 21G, and 21B are selected suitably according to a displayed picture and arranged.

The sensor 31 included in each pixel group is a pixel that detects a light quantity of the incident light L. The sensor 31 includes a light reception unit configured by, for example, a photodiode or the like.

In the self-power feeding type display device according to the present embodiment, eight reflection pixels each of which is one of the red color reflection pixel 21R, the green color reflection pixel 21G, and the blue color reflection pixel 21B form a pixel group 22. In the pixel group 22, eight reflection pixels is arranged in a ring form so that reflection pixels 21R, 21G, and 21B of the same color are not adjacent to each other. In addition, in the pixel group 22, the sensor pixel 31 is disposed in a center surrounded by a plurality of reflection pixels 21R, 21G, and 21B. The self-power feeding type display device according to the present embodiment is configured by arranging such a plurality of pixel groups 22 two-dimensionally.

By the way, the self-power feeding type display device according to the present embodiment has a structure in which one sensor pixel 31 is always included in each pixel group 22. However, the pixel group 22 including the sensor pixel 31 and a pixel group that does not include the sensor pixel 31 (a pixel group configured by only reflection pixels) may be mixedly present. That is, it suffices that the self-power feeding type display device according to the present embodiment has at least one sensor pixel 31.

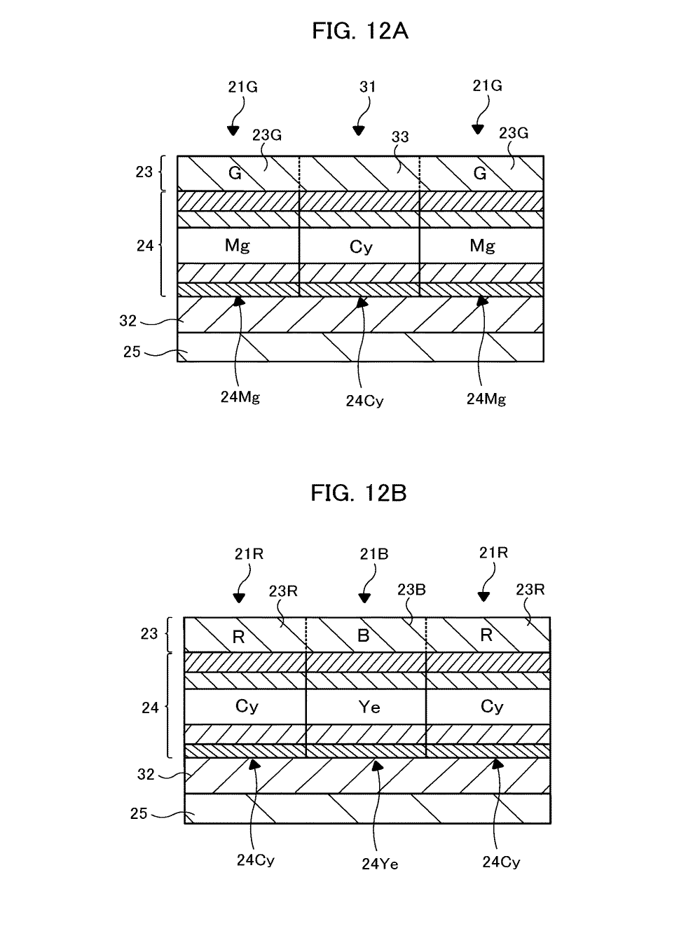

FIG. 12A is a sectional view of one pixel group 22 along a dot-dash line Xa-Xa′ illustrated in FIG. 11, and FIG. 12B is a sectional view of one pixel group 22 along a dot-dash line Xb-Xb′ illustrated in FIG. 11. Hereafter, structures of respective reflection pixels 21R, 21G and 21B and a structure of the sensor pixel 31 will be described in detail with reference to FIG. 12A and FIG. 12B. As illustrated in FIG. 12A and FIG. 12B, the reflective pixels 21R, 21G, and 21B of respective colors are configured by laminating a power generation layer 24 including a cyan color power generation unit 24Cy, a magenta color power generation unit 24Mg, and a yellow color power generation unit 24Ye, and a reflection layer 23 including a red color reflection unit 23R, a green color reflection unit 23G, and a blue color reflection unit 23B over a power storage unit 25 in the cited order in the same way as the reflection pixels 11R, 11G, and 11B in the self-power type display device 10, respectively.

Meanwhile, the sensor pixel 31 is configured by laminating the cyan color power generation unit 24Cy and a reflection unit 33 on a sensor unit 32 provided on a power storage unit 25 in the cited order.

The sensor unit 32 includes a light reception unit which receives the incident light L, and a gate which reads out signal charge generated in the light reception unit by receiving the incident light L. The light reception unit is configured by a photodiode provided on a surface of a semiconductor substrate such as, for example, a silicon substrate. The gate is configured by, for example, a transistor provided on the surface of the semiconductor substrate. By the way, it suffices that the sensor unit is provided in at least the sensor pixel 31. As illustrated, however, the sensor unit 32 may extend into the reflection pixels 21R, 21G, and 21B.

In the sensor pixel 31, for example, the cyan color power generation unit 24Cy is provided on the sensor unit as a power generation unit. However, the power generation unit provided in the sensor pixel 31 is not restricted to the cyan color power generation unit 24Cy, but may be a power generation unit that absorbs light in another wavelength band and generates power (for example, the magenta color power generation unit 24Mg or the yellow color power generation unit 24Ye). Furthermore, the sensor pixel 31 does not always need the power generation unit, and the power generation unit may not be provided in the sensor pixel 31.

In the sensor pixel 31, the reflection unit 33 is laminated on the cyan color power generation unit 24Cy. The reflection unit 33 is configured to transmit substantially all of the incident light L. The reflection unit 33 may be configured to be capable of reflecting the incident light outside a band for which light can be received in the light reception unit in the sensor unit 32 and a cyan color band for which light is absorbed in the cyan color power generation unit 24Cy. However, the reflection unit 33 is not a portion that is always needed, but may not be provided.

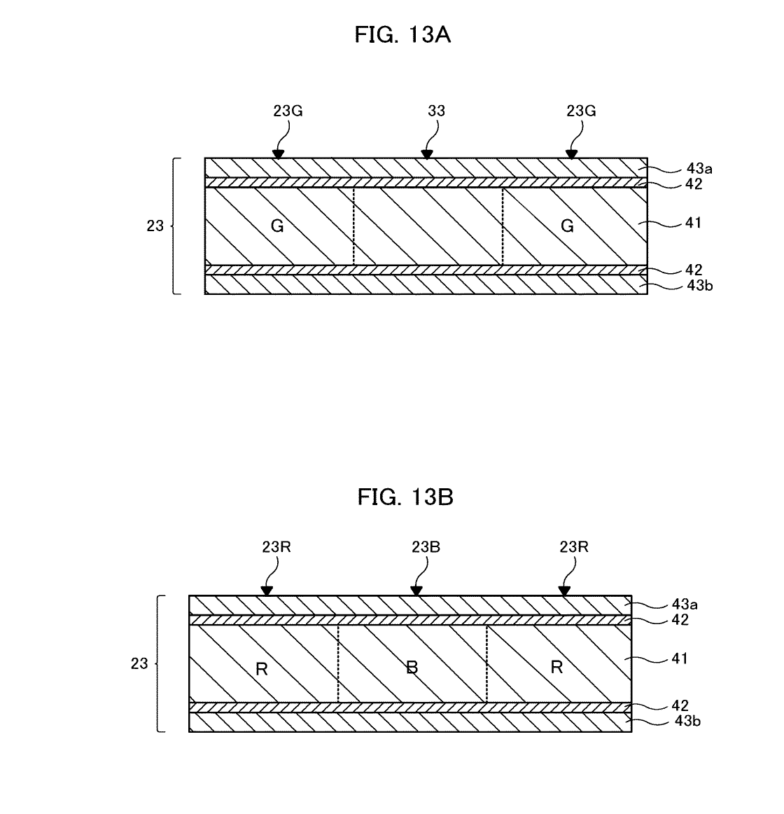

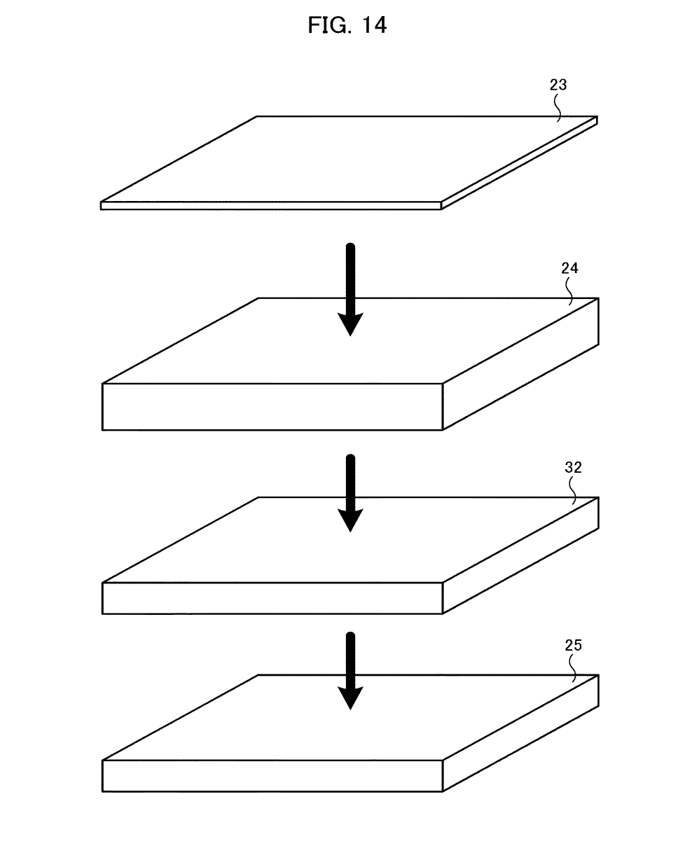

In the pixel group 22, the reflection units 23R, 23G, 23B, and 33 included in the plurality of reflection pixels 21R, 21G, and 21B and the sensor pixel 31 described heretofore configure the reflection layer 23 of the single layer. FIG. 13A and FIG. 13B are sectional views illustrating an example of a structure of the reflection layer 23. FIG. 13A is a sectional view corresponding to FIG. 12A, of the reflection layer 23. FIG. 13B is a sectional view corresponding to FIG. 12B, of the reflection layer 23.

As illustrated in FIG. 13A and FIG. 13B, the reflection layer 23 is configured by sandwiching a cholesteric liquid crystal layer 41 of a single layer which is formed to have reflection bands that are different from each other every pixel between one pair of transparent electrodes 43a and 43b via orientation films 42. In the present embodiment, one transparent electrode 43a is provided on a top surface side of the cholesteric liquid crystal layer 41 every pixel group 22. One transparent electrode 43b is provided on a bottom surface side of the cholesteric liquid crystal layer 41 every pixel group 22. In each pixel group 22, however, transparent electrodes 43a and 43b divided, for example, every pixel may be provided.

If a voltage is applied to the pair of transparent electrodes 43a and 43b in the reflection layer 23 having the above-described configuration, an electric field is generated in the cholesteric liquid crystal layer 41. The electric filed changes the orientation state of the cholesteric liquid crystal. In this way, the reflection wavelength band of the reflection layer 23 can be changed every pixel.

By the way, it suffices that the reflection band of the reflection layer 23 can be changed by an arbitrary reflection band change means including the transparent electrodes 43a and 43b. Therefore, the reflection layer 23 may be configured by a material that can be changed in refractive index, such as a photonic interlayer film or a plasmon layer.

Referring back to FIG. 12A and FIG. 12B, each of the cyan color power generation unit 24Cy, the magenta color power generation unit 24Mg and the yellow color power generation unit 24Ye included in the above-described plurality of reflection pixels 21R, 21G, and 21B and the sensor pixel 31 is configured by an organic solar battery in the same way as, for example, the self-power feeding type display device 10 according to the first embodiment. Such plurality of power generation units 24Cy, 24Mg and 24Ye configure the power generation layer 24.

As illustrated in FIG. 14, the self-power feeding type display device described heretofore can also be manufactured by forming each of the reflection layer 23, the power generation layer 24, the sensor unit 32, and the power storage unit 25 in a sheet form and sticking together the reflection layer 23, the power generation layer 24, the sensor unit 32, and the power storage unit 25 each formed in a sheet form. Therefore, it is facilitated to, for example, make the screen large.

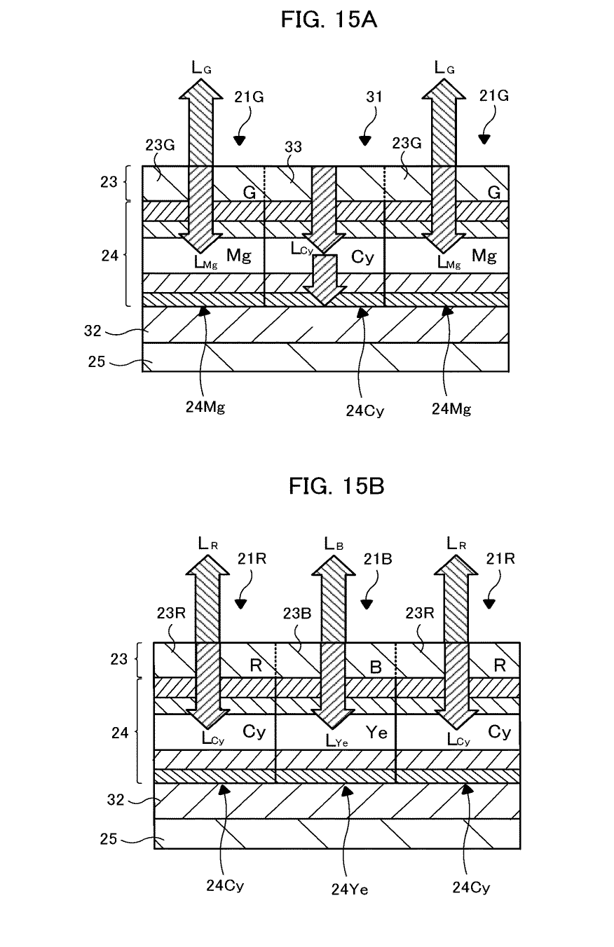

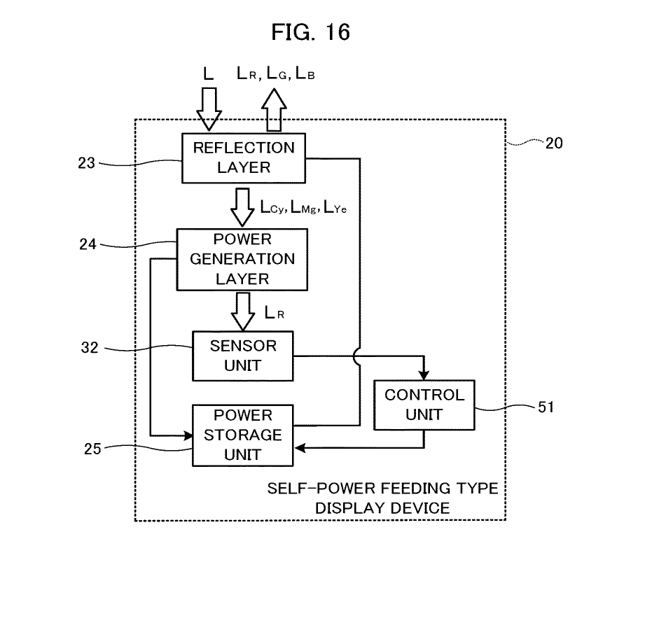

Operation of the self-power feeding type display device will now be described with reference to FIG. 15A, FIG. 15B, and FIG. 16. FIG. 15A is a sectional view corresponding to FIG. 12A, for explaining moves of light incident on the self-power feeding type display device according to the second embodiment. FIG. 15B is a sectional view corresponding to FIG. 12B, for explaining moves of light incident on the self-power feeding type display device according to the second embodiment. FIG. 16 is a functional block diagram illustrating the self-power feeding type display device according to the second embodiment.

First, if the incident light L is incident on the reflection pixels 21R, 21G, and 21B in the self-power feeding type display device, light having a wavelength in a predetermined band is reflected in the reflection layer 23 of each of the pixels 21R, 21G, and 21B. As illustrated in FIG. 15A and FIG. 15B, if the incident light L is incident on, for example, the red color reflection pixel 21R, the red color reflection unit 23R reflects red color light L_{R}. If the incident light L is incident on the green color reflection pixel 21G, the green color reflection unit 23G reflects green color light L_{G}. If the incident light L is incident on the blue color reflection pixel 21B, the blue color reflection unit 23B reflects blue color light L_{B}. In this way, the reflection layer 23 reflects light having a wavelength in a predetermined band. As a result, the self-power feeding type display device can display a picture according to the pixel arrangement. Light L_{Cy}, L_{Mg}, and L_{ye} that is included in the incident light L incident on the reflection pixels 21R, 21G, and 21B in the self-power feeding type display device and that is not reflected in the reflection layer 23 of the pixels 21R, 21G, and 21B is transmitted by the reflection layer 23 and arrives at the power generation layer 24. The light L_{Cy}, L_{Mg}, and L_{ye} arriving at the power generation layer 24 is absorbed in the layer 24 and power is generated. As illustrated in FIG. 15A and FIG. 15B, for example, cyan (Cy) color light L_{Cy} which is transmitted through the red color reflection unit 23R arrives at the cyan color power generation unit 24Cy and is absorbed in the cyan color power generation unit 24Cy and power is generated. In the same way, magenta (Mg) color light L_{Mg} which is transmitted through the green color reflection unit 23G arrives at the magenta color power generation unit 24Mg and is absorbed in the magenta color power generation unit 24Mg and power is generated. Yellow (Ye) color light L_{Ye} which is transmitted through the blue color reflection unit 23B arrives at the yellow color power generation unit 24Ye and is absorbed in the yellow color power generation unit 24Ye and power is generated. In this way, the light L_{Cy}, L_{Mg}, and L_{ye} that is not reflected in the reflection layer 23 is absorbed in the power generation layer 24. As a result, the self-power feeding type display device can absorb the light L_{Cy}, L_{Mg}, and L_{ye} that is unnecessary for picture display and generate power.

As illustrated in FIG. 16, power generated in the power generation layer 24 can be stored in the power storage unit 25. It is possible to take out the power stored in the power storage unit 25 according to, for example, a command from a control unit 51, which controls the power storage unit 25 and supply the power to a place specified by the control unit 51.

In contrast, if the incident light L is incident on the sensor pixel 31 as illustrated in FIG. 15A, the reflection unit 33 included in the pixel 31 does not substantially reflect the incident light L and the incident light L is transmitted.

The incident light L transmitted by the reflection unit 33 in the sensor pixel 31 arrives at the cyan color power generation unit 24Cy included in the sensor pixel 31 and is absorbed in the power generation unit 24Cy, and power is generated. Power generated in the cyan color power generation unit 24Cy is stored in the power storage unit 25 as illustrated in FIG. 15A.

Light that is not absorbed in the cyan color power generation unit 24Cy (for example, the red color light L_{R}) is transmitted through the cyan color power generation unit 24Cy and arrives at a light reception unit (not illustrated) in the sensor unit 32. The light reception unit generates an electric signal depending upon the light quantity of light L_{R} arriving at the light reception unit. The electric signal generated in the light reception unit is taken out by a gate, which is provided separately in the sensor unit 32, and is supplied to the control unit as illustrated in FIG. 16.

A method for changing a picture displayed by the self-power feeding type display device will now be described.

For example, if a portion of the self-power feeding type display device is touched with a hand, a light quantity of light incident on the sensor pixel 31 that is present in an area touched with the hand lowers. Therefore, alight quantity of light arriving at the light reception unit in the sensor pixel 31 also lowers and a voltage of the electric signal generated in the light reception unit also lowers. Accordingly, an electric signal having a low voltage arrives at the control unit 51.

If the voltage of the electric signal supplied from the light reception unit changes in this way, the control unit 51 detects the change, takes out power from the power storage unit 25, and supplies the power taken out to the reflection layer 23 (for example, one pair of transparent electrodes 43a and 43b having the cholesteric liquid crystal layer 41 sandwiched between them).

If power is supplied to the transparent electrodes 43a and 43b, an electric field is generated in the cholesteric liquid crystal layer 41 sandwiched between the transparent electrodes 43a and 43b. The orientation state of the cholesteric liquid crystal changes according to the electric field. As a result, the wavelength band of light reflected in the reflection layer 23 is changed. Accordingly, the displayed picture is also changed.

That is, in the self-power feeding type display device according to the present embodiment, the displayed picture can be changed by, for example, touching a portion of the self-power feeding type display device and consequently changing the light reception quantity in the sensor pixel 31.

In the self-power feeding type display device described heretofore, it is also possible to reduce the supply quantity of power generated outside the self-power feeding type display device to the self-power feeding type display device by a reason similar to that of the self-power feeding type display device 10 according to the first embodiment.

In addition, in the self-power feeding type display device according to the second embodiment as well, a desired picture can be displayed normally even if the light quantity of light incident on the self-power feeding type display device according to the second embodiment is small, by a reason similar to that of the self-power feeding type display device 10 according to the first embodiment.

In addition, in the self-power feeding type display device according to the second embodiment, the reflection wavelength band of the reflection layer 23 is changed by supplying stored power to the transparent electrodes 43a and 43b having the cholesteric liquid crystal layer 41 sandwiched between them. Therefore, the displayed picture can be changed without using power supplied from the outside of the self-power feeding type display device or by using only slightly power supplied from the outside of the self-power feeding type display device.

### <Modification>

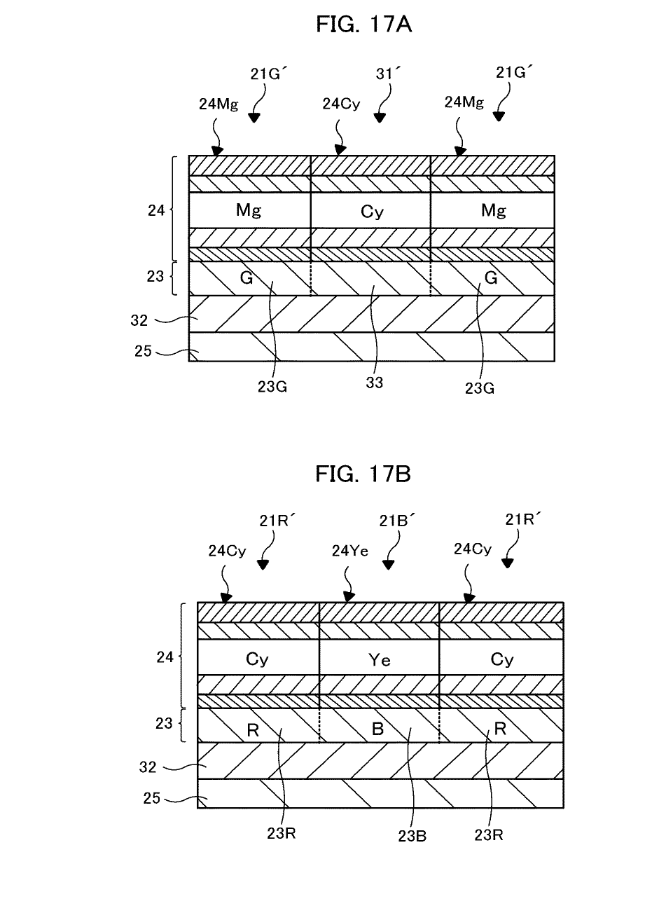

FIG. 17A is a sectional view corresponding to FIG. 12A, of one pixel group included in a self-power feeding type display device according to a modification of the second embodiment. FIG. 17B is a sectional view corresponding to FIG. 12B, of one pixel group included in the self-power feeding type display device according to the modification of the second embodiment. As illustrated in FIG. 17A and FIG. 17B, the reflection layer 23 and the power generation layer 24 may be laminated over the power storage unit 25 of the single layer in the cited order. That is, a red color reflection pixel 21R′ may be configured by laminating the red color reflection unit 23R and the cyan color power generation unit 24Cy over the power storage unit 25 in the cited order. A green color reflection pixel 21G′ may be configured by laminating the green color reflection unit 23G and the magenta color power generation unit 24Mg over the power storage unit 25 in the cited order. A blue color reflection pixel 21B′ may be configured by laminating the blue color reflection unit 23B and the yellow color power generation unit 24Ye over the power storage unit 25 in the cited order. In addition, a sensor pixel 31′ may be configured by laminating the reflection unit 33 and the cyan color power generation unit 24Cy over the power storage unit 25 in the cited order.

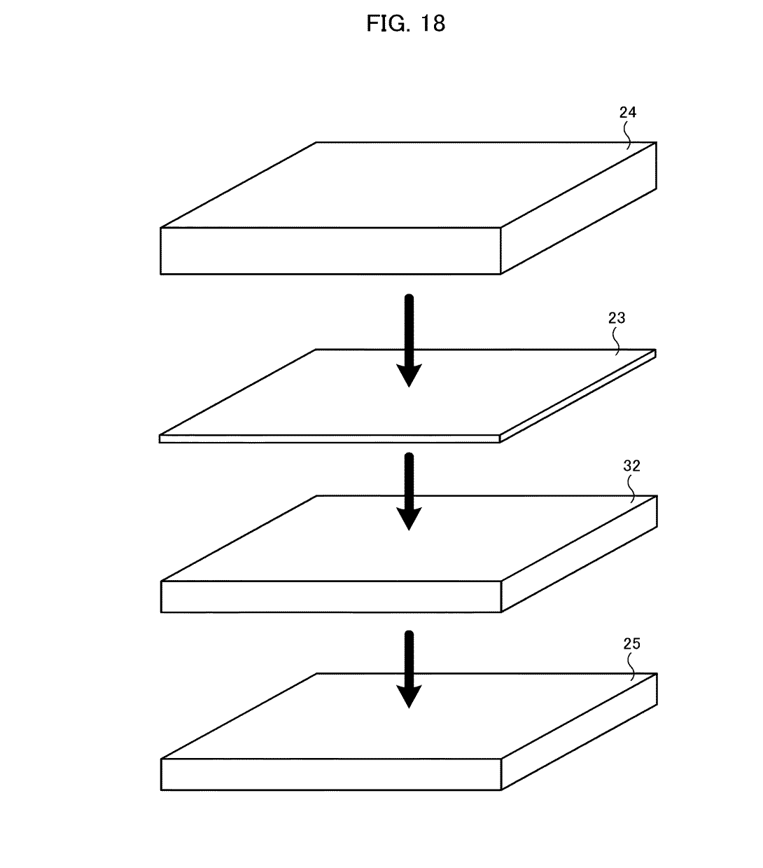

The self-power feeding type display device configured by the reflection pixels 21R′, 21G′, and 21B′ and the sensor pixel 31′ having such structures can be manufactured in the same way as the self-power feeding type display device according to the second embodiment. That is, as illustrated in FIG. 18, the self-power feeding type display device can be manufactured by forming each of the reflection layer 23, the power generation layer 24, the sensor unit 32 and the power storage layer 25 in a sheet form and sticking together the reflection layer 23, the power generation layer 24, the sensor unit 32 and the power storage layer 25 each formed in a sheet form. Therefore, it is facilitated to, for example, make the screen large.

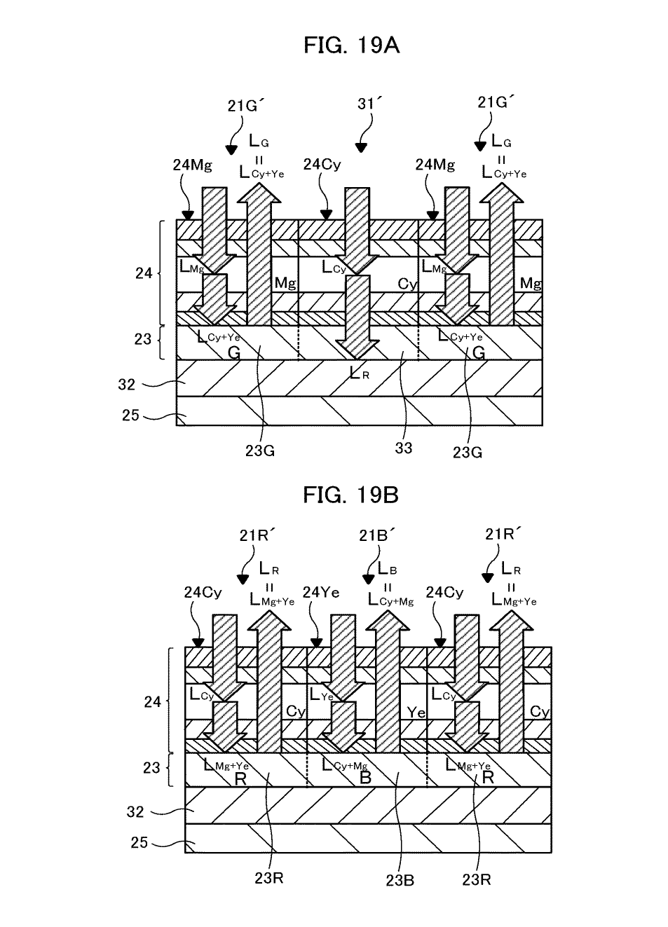

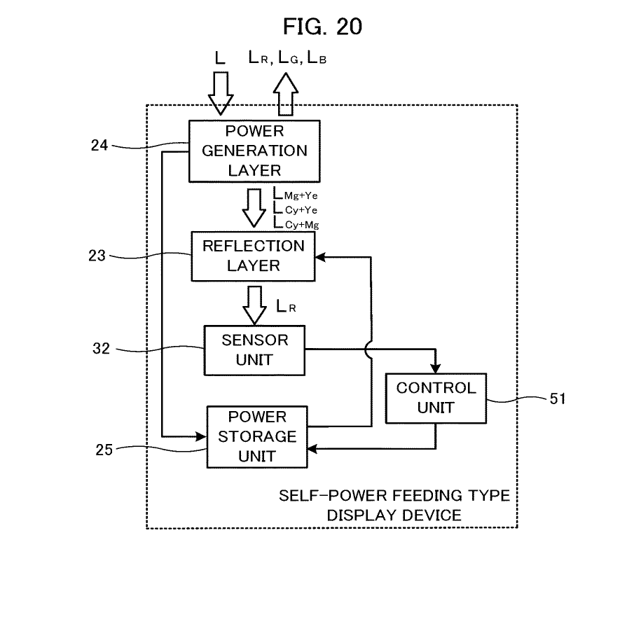

Operation of the self-power feeding type display device will now be described with reference to FIG. 19A, FIG. 19B, and FIG. 20. FIG. 19A is a sectional view corresponding to FIG. 17A, for explaining moves of light incident on the self-power feeding type display device according to the modification of the second embodiment. FIG. 19B is a sectional view corresponding to FIG. 17B, for explaining moves of light incident on the self-power feeding type display device according to the modification of the second embodiment. FIG. 20 is a functional block diagram illustrating the self-power feeding type display device according to the modification of the second embodiment.

First, if the incident light L is incident on the self-power feeding type display device according to the modification, light having a wavelength in a predetermined band is absorbed in the power generation layer 24 and power is generated. As illustrated in FIG. 19A and FIG. 19B, cyan color light L_{cy} included in the incident light L arriving at the layer 24Cy is absorbed in the cyan color power generation unit 24Cy and power is generated. In the same way, magenta color light L_{Mg} included in the incident light L arriving at the layer 24Mg is absorbed in the magenta color power generation unit 24Mg and power is generated. Yellow color light L_{Ye} included in the incident light L arriving at the layer 24Ye is absorbed in the magenta color power generation unit 24Ye and power is generated.

Light that is not absorbed in the power generation layer 24 is transmitted through the power generation layer and arrives at the reflection layer 23. The light arriving at the reflection layer 23 is reflected in the reflection layer 23, transmitted through the power generation layer 24, and emitted to the outside of the self-power feeding type display device according to the modification. As illustrated in FIG. 19A and FIG. 19B, light L_{Mg+Ye} of magenta color+yellow color, which is not absorbed in the cyan color power generation unit 24Cy, i.e., the red color light L_{R} is transmitted through the cyan color power generation unit 24Cy and arrives at the red color reflection unit 23R. The light arriving at the red color reflection unit 23R is reflected in the red color reflection unit 23R, transmitted through the cyan color power generation unit 24Cy, and emitted to the outside of the self-power feeding type display device according to the modification. In the same way, light L_{Cy+Ye} of cyan color+yellow color, which is not absorbed in the magenta color power generation unit 24Mg, i.e., the green color light L_{G} is transmitted through the magenta color power generation unit 24Mg and arrives at the green color reflection unit 23G. The light arriving at the green color reflection unit 23G is reflected in the green color reflection unit 23G, transmitted through the magenta color power generation unit 24Mg, and emitted to the outside of the self-power feeding type display device according to the modification. Light L_{Cy|Mg} of cyan color+magenta color, which is not absorbed in the yellow color power generation unit 24Ye, i.e., the blue color light L_{B} is transmitted through the yellow color power generation unit 24Ye and arrives at the blue color reflection unit 23B. The light arriving at the blue color reflection unit 23B is reflected in the blue color reflection unit 23B, transmitted through the yellow color power generation unit 24Ye, and emitted to the outside of the self-power feeding type display device according to the modification. In this way, the reflection layer 23 reflects light having a wavelength in a predetermined band. As a result, the self-power feeding type display device according to the modification can display a picture according to a pixel arrangement. In addition, the self-power feeding type display device according to the modification can absorb the light L_{cy}, L_{Mg}, and L_{ye}, which is unnecessary for display of the picture, and generate power.

As illustrated in FIG. 20, the power generation layer 24 and the power storage unit 25 are connected electrically by wiring, which is not illustrated. Power generated in the power generation layer 24 can be stored in the power storage unit 25. The power stored in the power storage unit 25 can be taken out as occasion demands. Power required when the self-power feeding type display device according to the modification operates can be taken out from the power storage unit 25 and used.

In contrast, if the incident light L is incident on the sensor pixel 31′ as illustrated in FIG. 19A, the cyan color power generation unit 24Cy included in the pixel 31′ absorbs cyan color light L_{Cy} out of the incident light L and generates power. The generated power is stored in the stored in the power storage unit 25 as illustrated in FIG. 20.

Light that is not absorbed in the cyan color power generation unit 24Cy (red color light L_{R}) is transmitted through the cyan color power generation unit 24Cy, further transmitted through the reflection unit 33 as well, and arrives at the light reception unit (not illustrated) in the sensor unit 32. The light reception unit generates an electric signal depending upon a light quantity of the light L_{R} arriving at the light reception unit. The electric signal generated in the light reception unit is taken out by a gate provided separately in the sensor unit 32 and supplied to the control unit 51 as illustrated in FIG. 20.

For example, if a light quantity of light incident on the sensor pixel 31′ lowers by touching a portion of the self-power feeding type display device according to the modification with a hand, a voltage of the electric signal supplied to the control unit 51 lowers. If the voltage of the electric signal supplied from the light reception unit changes in this way, the control unit 51 detects the change, takes out power from the power storage unit 25, and supplies the power taken out to the reflection layer 23 (for example, one pair of transparent electrodes 43a and 43b having the cholesteric liquid crystal layer sandwiched between them).

If power is supplied to the transparent electrodes 43a and 43b, an electric field is generated in the cholesteric liquid crystal layer 41 sandwiched between the transparent electrodes 43a and 43b. The orientation state of the cholesteric liquid crystal changes according to the electric field. As a result, the wavelength band of light reflected in the reflection layer 23 is changed. Accordingly, the displayed picture is also changed. In the self-power feeding type display device according to the modification of the second embodiment as well, the displayed picture can be changed by changing the light reception quantity in the sensor pixel 31′ in this way.

In the self-power feeding type display device according to the modification of the second embodiment described heretofore as well, it is also possible to reduce the supply quantity of power generated outside the self-power feeding type display device to the self-power feeding type display device by a reason similar to that in the self-power feeding type display device according to the second embodiment.

In addition, in the self-power feeding type display device according to the modification of the second embodiment as well, the displayed picture can be changed without using power supplied from the outside of the self-power feeding type display device or by using only slightly power supplied from the outside of the self-power feeding type display device, in the same way as the self-power feeding type display device according to the second embodiment.

Furthermore, in the self-power feeding type display device according to the modification of the second embodiment, the power generation layer 24 is disposed on the reflection layer 23. As compared with the self-power feeding type display device according to the second embodiment, therefore, the absorption quantity of light in the power generation layer 24 can be increased. Accordingly, the power generation quantity can be increased.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in each of the above-described embodiments, the power storage units 15 and 25 are included within the self-power feeding type display device. As a result, wiring connecting the power generation layers 14 and 24 to the power storage units 15 and 25, and wiring connecting the power storage units 15 and 25 to each unit in the self-power feeding type display device can be shortened. Therefore, it is possible to suppress power consumption caused by wiring and utilize power efficiently. However, it is not always necessary to include the power storage units 15 and 25 within the self-power feeding type display device, but the power storage units 15 and 25 may be disposed outside the self-power feeding type display device.

What is claimed is:

1. A self-power feeding type display device comprising:
a plurality of reflection pixels including a reflection unit configured to reflect light in a first band and a power generation unit configured to absorb light in a second band different from the first band and generate power, the plurality of reflection pixels being configured by laminating the reflection unit and the power generation unit; and
a power storage unit configured to store power generated in the power generation unit.

2. The self-power feeding type display device according to claim 1, wherein
a plurality of the reflection units take a shape of one sheet, and
a plurality of the power generation units take a shape of one sheet.

3. The self-power feeding type display device according to claim 2, wherein each of the plurality of reflection units and the plurality of power generation units is provided on or over the power storage unit taking a shape of one sheet.

4. The self-power feeding type display device according to claim 2, wherein the plurality of reflection units are laminated on the plurality of power generation units.

5. The self-power feeding type display device according to claim 2, wherein the plurality of power generation units are laminated on the plurality of reflection units.

6. The self-power feeding type display device according to claim 2, wherein the plurality of the reflection units comprise a cholesteric liquid crystal layer in which the first band is changed by applying an electric field, and one pair of transparent electrodes configured to form the electric field in the cholesteric liquid crystal layer.

7. The self-power feeding type display device according to claim 2, wherein each of the plurality of the power generation units comprises an organic solar battery layer.

8. The self-power feeding type display device according to claim 1, wherein the plurality of reflection pixels comprise a red color reflection pixel configured to reflect red color light, a green color reflection pixel configured to reflect green color light, and a blue color reflection pixel configured to reflect blue color light.

9. The self-power feeding type display device according to claim 8, wherein
the power generation unit included in the red color reflection pixel is a cyan color power generation unit configured to absorb cyan color light and generate power,
the power generation unit included in the green color reflection pixel is a magenta color power generation unit configured to absorb magenta color light and generate power, and
the power generation unit included in the blue color reflection pixel is a yellow color power generation unit configured to absorb yellow color light and generate power.

10. The self-power feeding type display device according to claim 1, further comprising:
a sensor unit configured to receive light and generate an electric signal according to a light quantity of the received light; and
a control unit configured to control the power storage unit according to the electric signal generated in the sensor unit,
wherein the self-power feeding type display device is configured by arranging the plurality of the reflection pixels and a sensor pixel having the sensor unit.

11. The self-power feeding type display device according to claim 10, wherein
the control unit controls the power storage unit to supply the power stored in the power storage unit to the reflection unit on the basis of a voltage change of the electric signal generated in the sensor unit, and
the first band in the reflection unit is changed by power supplied from the power storage unit.

12. The self-power feeding type display device according to claim 10, wherein
a plurality of the reflection units take a shape of one sheet, and
a plurality of the power generation units take a shape of one sheet.

13. The self-power feeding type display device according to claim 12, wherein each of the plurality of reflection units and the plurality of power generation units is provided on or over the power storage unit taking a shape of one sheet.

14. The self-power feeding type display device according to claim 12, wherein the plurality of reflection units are laminated on the plurality of power generation units.

15. The self-power feeding type display device according to claim 12, wherein the plurality of power generation units are laminated on the plurality of reflection units.

16. The self-power feeding type display device according to claim 12, wherein the plurality of reflection units comprise a cholesteric liquid crystal layer in which the first band is changed by applying an electric field, and one pair of transparent electrodes configured to form the electric field in the cholesteric liquid crystal layer.

17. The self-power feeding type display device according to claim 12, wherein each of the plurality of power generation units comprises an organic solar battery layer.

18. The self-power feeding type display device according to claim 10, wherein the plurality of reflection pixels comprise a red color reflection pixel configured to reflect red color light, a green color reflection pixel configured to reflect green color light, and a blue color reflection pixel configured to reflect blue color light.

19. The self-power feeding type display device according to claim 18, wherein
the power generation unit included in the red color reflection pixel is a cyan color power generation unit configured to absorb cyan color light and generate power,
the power generation unit included in the green color reflection pixel is a magenta color power generation unit configured to absorb magenta color light and generate power, and
the power generation unit included in the blue color reflection pixel is a yellow color power generation unit configured to absorb yellow color light and generate power.
